(19) United States
(12) Patent Application Publication
(10) Pub. No.: US 2024/0083513 A1
(43) Pub. Date: Mar. 14, 2024

(54) ROCKER INSERT WITH PLURALITY OF ENCLOSED SECTIONS

(71) Applicant: Shape Corp., Grand Haven, MI (US)

(72) Inventors: Matthew Kuipers, Holland, MI (US); Zehua Qin, Norton Shores, MI (US)

(73) Assignee: Shape Corp., Grand Haven, MI (US)

(21) Appl. No.: 18/466,715

(22) Filed: Sep. 13, 2023

Related U.S. Application Data
(60) Provisional application No. 63/375,612, filed on Sep. 14, 2022.

(51) Int. Cl. B62D 25/02; B62D 21/15

(52) U.S. Cl. CPC B62D 25/025; B62D 21/157

(57) ABSTRACT

A vehicle rocker assembly includes a sill outer and a sill inner that together define an elongated hollow interior. The vehicle rocker assembly also includes a rocker insert disposed within the elongated hollow interior. The rocker insert includes a top wall, a bottom wall, a side wall coupled to and extending between the top wall and the bottom wall, with the top wall, the bottom wall, and the side wall at least partially defining a second hollow interior. The rocker insert also includes a stiffening member at least partially disposed within the second hollow interior and configured to be produced by extrusion, the stiffening member defining a plurality of enclosed sections extending along a length of the elongated hollow interior. Moreover, plurality of enclosed sections are configured to carry a load path laterally between the inboard and outboard wall portions.

### CROSS-REFERENCE TO RELATED APPLICATION

This application claims priority under 35 U.S.C. § 119(e) to U.S. Provisional Patent Application No. 63/375,612, filed Sep. 14, 2022, the disclosure of this prior application is considered part of this application and is hereby incorporated by reference in its entirety.

### TECHNICAL FIELD

The present disclosure relates to sill assemblies and more specifically to rocker inserts for vehicle body structures.

### BACKGROUND

Vehicle frames and body structures are designed to support the vehicle and undergo and absorb certain levels of impact forces, such as to prevent distances of inboard intrusion into the vehicle in accordance with insurance requirements and other regulatory and legal requirements. Side impacts to a vehicle are commonly tested with side pole impact testing, which direct significant side impact forces to the vehicle. Vehicle frames primarily absorb these side impacts at rocker sections that run longitudinally between the front and rear wheels along the lower outboard portions of the vehicle frame.

With the incorporation of battery trays in electric and hybrid electric vehicles in the lateral inboard area between opposing rocker sections, it is desirable for the side impact forces to be directed away from the battery tray and towards a vehicle floor cross member. For example, it is generally known to increase stiffness of a vehicle sill assembly such as by adding a rocker insert within the vehicle sill assembly.

### SUMMARY

The present disclosure provides a vehicle rocker assembly. Examples of the vehicle rocker assembly may include one or more of a sill outer or a sill inner to define an elongated hollow interior defined by one or more of an inboard wall portion of the sill inner and an outboard wall portion of the sill outer. The vehicle rocker assembly also includes a rocker insert disposed within the elongated hollow interior. The rocker insert includes a channel section having a top wall, a bottom wall, and a side wall coupled to and extending between the top wall and the bottom wall, with the top wall, the bottom wall, and the side wall at least partially defining a second hollow interior. A stiffening member is comprised of aluminum and at least partially disposed within the second hollow interior of the channel section. Moreover, the stiffening member is configured to be produced by extrusion. Additionally, the stiffening member defines a plurality of enclosed sections extending along a length of the elongated hollow interior.

Implementations of the disclosure may include one or more of the following optional features.

In some implementations, the highest point of the plurality of enclosed sections extends in a lateral vehicle direction.

In some examples, the top wall, the bottom wall, and the side wall of the rocker insert are formed by extrusion.

In some examples, a cross-sectional shape of the plurality of enclosed sections comprises a shape with a series of highest points extending in parallel with each other.

In some examples, the highest point of the plurality of enclosed sections is generally flat.

In some examples, wherein the highest point of the plurality of enclosed sections and a lowest point of the plurality of enclosed sections are disposed on the same vertical plane.

In some examples, the highest point of the plurality of enclosed sections extends at least partially between the sill wall portions of the sill inner and the sill outer.

In some examples, the side wall is coupled with the sill inner or the sill outer to support the rocker insert in the elongated hollow interior.

In some examples, the top wall, the bottom wall, and the side wall of the rocker insert are comprised of aluminum.

In some examples, the plurality of enclosed sections comprises a plurality of repeating o-shapes.

In some examples, the plurality of enclosed sections comprises a plurality of repeating hexagonal shapes.

In some implementations, a rocker insert is disposed with a hollow interior of a sill assembly, the sill assembly including at least one of a sill outer having an outboard wall portion and a sill inner having an inboard wall portion defining the hollow interior. The rocker insert includes a top wall, a bottom wall, and a side wall coupled to and extending between the top wall and the bottom wall, with the top wall, the bottom wall, and the side wall at least partially defining a channel member that partially surrounds a second hollow interior. A stiffening member is comprised of aluminum and at least partially disposed within the second hollow interior. Moreover, the stiffening member is configured to be produced by extrusion. Additionally, the stiffening member defines a plurality of enclosed sections extending along a length of the elongated hollow interior. Moreover, a highest point of the plurality of enclosed sections is configured to carry a load path laterally between the inboard and outboard wall portions.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is an side elevation view of a vehicle schematically showing a rocker assembly and a battery tray enclosure;

FIG. 2 is a perspective view of a vehicle schematically showing a rocker assembly and other structural components;

FIG. 3 is a cross-sectional view of an example of a vehicle rocker assembly including a rocker insert;

FIG. 4A is a side view of the rocker insert shown in FIG. 3;

FIG. 4B is another side view of the rocker insert shown in FIG. 3;

FIG. 4C is an end view of the rocker insert shown in FIG. 3;

FIG. 5A is a perspective view of the rocker insert shown in FIG. 3;

FIG. 5B is a perspective view of the rocker insert shown in FIG. 3;

FIG. 6A is a perspective view of a plurality of enclosed sections of the rocker insert;

FIG. 6B is a front view of the plurality of enclosed sections of the rocker insert of FIG. 4A;

FIG. 7 is a front view of another example of a plurality of enclosed sections of a rocker insert;

FIG. 8 is a front view of another example of a plurality of enclosed sections of a rocker insert;

FIG. 9 is a front view of another example of a plurality of enclosed sections of a rocker insert;

FIG. 10 is a front view of another example of a plurality of enclosed sections of a rocker insert;

FIG. 11 is a front view of another example of a plurality of enclosed sections of a rocker insert;

FIG. 12 is a front view of another example of a plurality of enclosed sections of a rocker insert;

FIG. 13 is a front view of another example of a plurality of enclosed sections of a rocker insert; and

FIGS. 14 and 15 are graphs illustrating 3-point bend displacement of a rocker insert placed under load.

Like reference numerals indicate like parts throughout the drawings.

### DETAILED DESCRIPTION

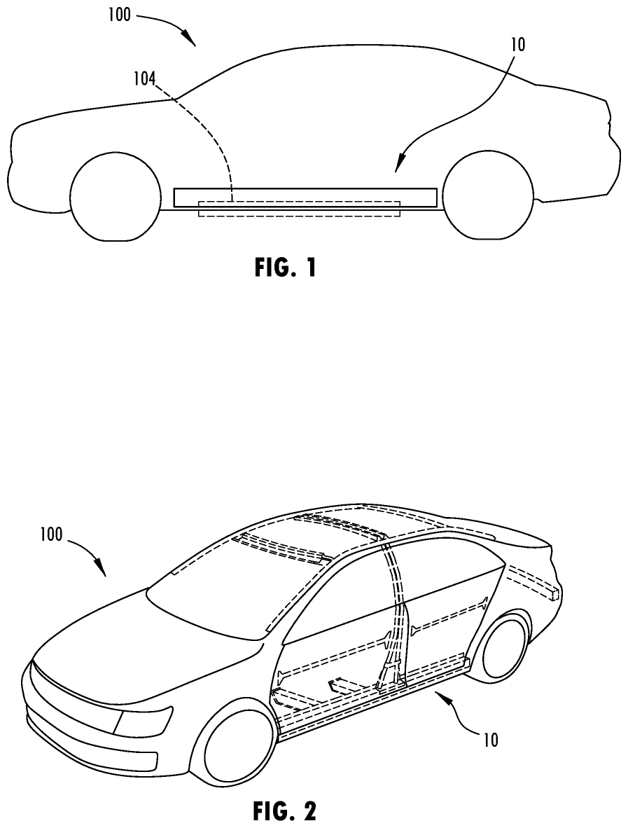

Referring now to the drawings and the illustrative embodiments depicted therein, a rocker assembly is provided for a vehicle 100, such as for a body structure or frame 101 as shown in FIGS. 1 and 2. The vehicle frame 101 and associated components may have various designs and configurations, such as for different styles and types of vehicles. As shown for example FIGS. 1 and 2, the vehicle frame has various structural component, including a B-pillar 103, a hinge pillar 104, a floor cross-member 105, a roof bow 106, and a header 107, among other structural components that support the body of the vehicle and protect passengers, engine components, and sensitive electronics from damage when undergoing collisions. In some examples, the vehicle may be operated by a propulsion system that uses a battery, such as a battery or battery modules that may be supported in a battery tray 108 generally located between the axles and below the floor 109 to distribute the battery weight and establish a low center of gravity for the vehicle.

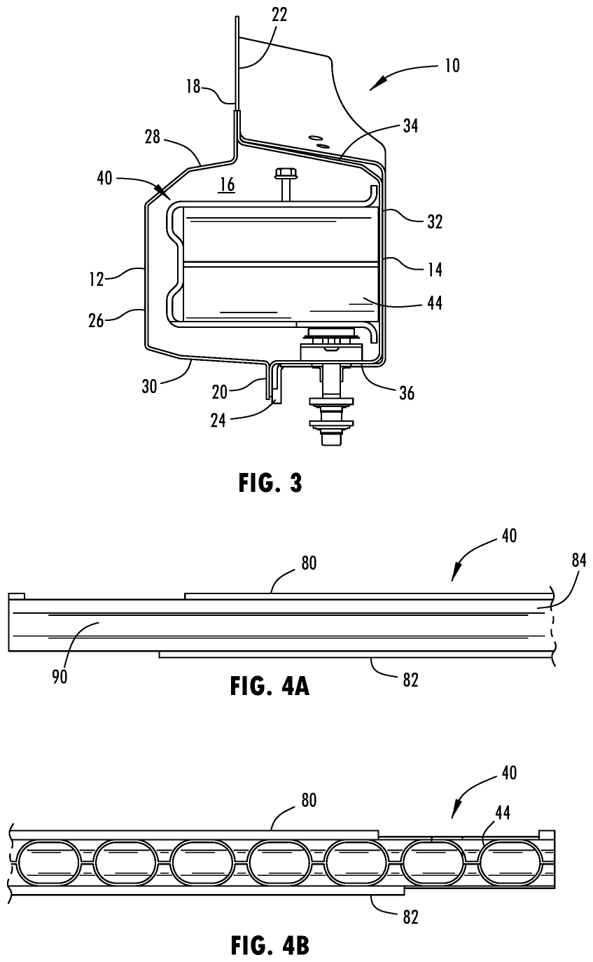

The vehicle rocker component includes a sill panel or panels, such as a sill inner panel 12 and sill outer panel 14 that attach together around an interior area 16, where the terms “inner” and “outer” are made in reference to inboard or inward facing and outboard or outward facing directions on the vehicle, such oriented in FIG. 1. As shown in FIGS. 2 and 3, the example of the vehicle rocker assembly 10 is provided with a reinforcement insert disposed in the interior area 16 to form a multi-tubular rocker structure. The rocker assembly 10 shown in FIG. 2 is disposed alongside an outer section of a battery tray 108 with the floor cross-member 105 being attached to the vehicle rocker assembly 10 so as to span laterally over the battery tray 108. Accordingly, the vehicle component in additional implementations may also or alternatively be provided as a battery tray frame component, such as a longitudinally oriented side wall section of the battery tray.

When designing the vehicle rocker assembly with a rocker insert disclosed herein, the outer dimensions of the vehicle rocker assembly may be reduced and the overall weight of the vehicle rocker assembly may be reduced while meeting the required impact and loading conditions. The rocker insert may span a partial section of the vehicle rocker assembly or the entire length of the rocker assembly, such as to extend beyond the rocker assembly into and to also reinforce an adjacent component. The rocker insert disclosed herein may comprise the entire vehicle component or may be joined to additional reinforcements or parts of the vehicle component, such as at desired sections of the vehicle component. Further, in some examples the rocker assembly may be embodied as a subassembly or as part of a corresponding vehicle component, such as a structural component or a battery tray component and as such may be designed to undergo various impact forces and to support and sustain different loading conditions.

Moreover, the rocker insert disclosed herein may be formed with one or more pieces of sheet material, such as by roll forming a metal sheet, to provide the structure with a relatively high strength (for shear and axial loading) and low weight in comparison to common rocker panels, such as to allow the still panels of the corresponding vehicle component (if provided) to use less material, occupy a smaller packaging space, and have greater flexibility in the outer shape design. The cross-sectional shape of different examples of the vehicle component and rocker insert may include various shapes and thicknesses for the desired application of the vehicle component.

Unless specified to the contrary, it is generally understood that additional implementations of the rocker component may have an opposite orientation from the examples shown and described, such as where the sill panels identified as an inner panel may be used as the outer panel and the sill panels identified as an outer panel may be used as the inner panel. The cross-sectional shape of the inner and outer panels may vary along the rocker, such as, for example, by flaring outward at the ends.

Referring now to the vehicle rocker assembly 10 shown in FIG. 3, a first sill panel 12 and a second sill panel 14 are attached together to surround a hollow interior space 16 between the sill panels 12, 14. The vehicle rocker assembly 10 shown in FIG. 3 is embodied as a vehicle rocker component. Accordingly, the first sill panel 12 may be referred to as a sill inner panel of a rocker component. The first sill panel 12 has an upper flange 18 and a lower flange 20 that extend along respective upper and lower edges of the inner panel. The first sill panel 12 protrudes inboard from the upper and lower flanges 18, 20 to form outward facing concave structures. The second sill panel 14, which may be referred to as a sill outer panel of a rocker component, has a C-shaped cross section with flanges 22, 24, which may similarly be referred to as an upper flange 22 and a lower flange 24. The upper flanges 18, 22 and the lower flanges 20, 24 of the inner and outer sill panels 12, 14 are attached together, such as via welding, with the concave structures facing each other. The upper and lower flanges 18, 20, 22, 24 of each of the sill panels 12, 14 shown in FIG. 3 extend longitudinally, continuously along the edges of the rocker component; however, it is contemplated that the flanges may be trimmed away in select areas to facilitate frame attachment or to reduce weight.

As further shown in FIG. 3, the inner and outer sill panels 12, 14 are joined together to define a hollow interior space 16 between the sill panels 12, 14. The upper and lower flanges 18, 20, 22, 24 are substantially planar and oriented in a generally vertical configuration, such as to mate in generally continuous contact along the length of the component. The upper and lower flanges 18, 20, 22, 24 may be joined together via welding, and preferably spot welding, although it is conceivable that alternative welding methods or joining means may be used in addition or in the alternative to spot welding in different implementations of a rocker component, such as adhesive or fasteners or the like.

The first sill panel 12, or inner panel of the vehicle rocker assembly 10, has an inner wall 26 that is substantially planar. The inner wall 26 integrally interconnects with a corner transition to an upper wall 28 and a lower wall 30 at the respective upper and lower ends. The corner transitions are approximately 90 degrees between the inner wall 26 and the upper and lower walls 28, 30. Also, the corner transitions are defined by the longitudinal bends to a sheet material that forms the first sill panel 12, such as a metal sheet (e.g., an advanced high strength steel sheet or aluminum sheet). Similarly, the upper and lower walls 28, 30 each have a corner transition of approximately 90 degrees to the upper flange 18 and the lower flange 20, respectively. The corner transitions are also defined by longitudinal bends in the sheet material of the first sill panel 12, such as formed by a roll form process. As also shown in FIG. 3, the upper and lower flanges 18, 20 are substantially planar and oriented in parallel alignment with the planar extent of the inner wall 26. The upper and lower walls 28, 30 of the first sill panel 12 are also substantially planar and, as shown in FIG. 3, are substantially parallel to each other, although in additional examples they may be slightly angled from each other. The corner transitions may also have an angular transition greater or less than shown in FIG. 3, such as approximately between 40 and 120 degrees, between 70 and 100 degrees, between 80 and 95 degrees, or between 82 and 92 degrees.

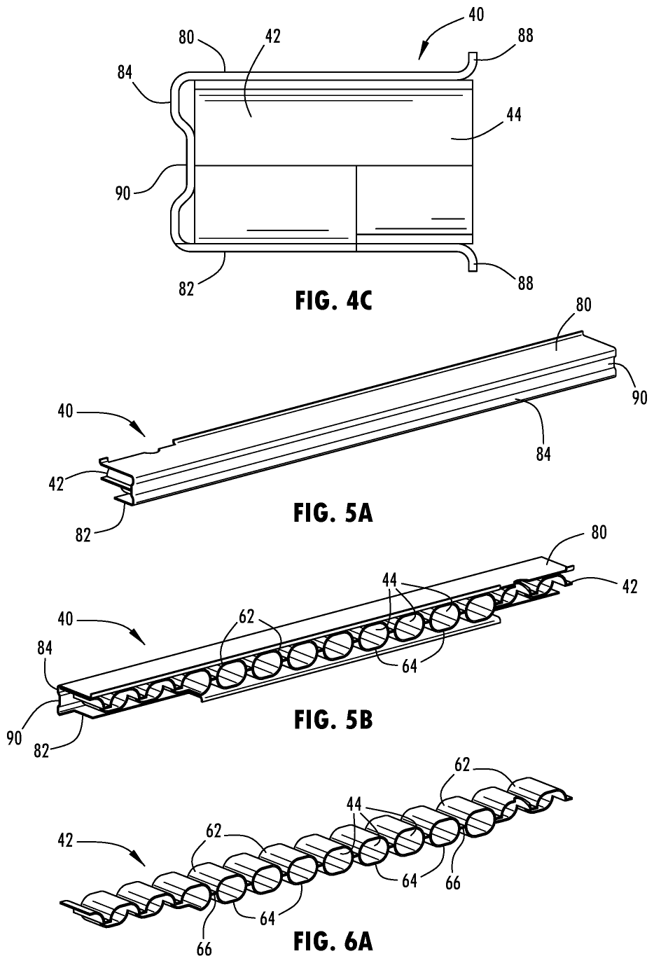

As also shown in FIG. 3, the second sill panel 14 or outer panel of the vehicle rocker assembly 10 has an outer wall 32 that is substantially planar and integrally interconnects with an upper wall 34 and a lower wall 36 at its respective upper and lower ends. The corner transitions of approximately 80 degrees between the outer wall 32 and the upper and lower walls 34, 36 are defined by longitudinal bends to a sheet material that forms the second sill panel 14. The sheet material may be the same or different from the first sill panel 12 and may include a metal sheet, such as an advanced high strength steel sheet or aluminum sheet. Similarly, the upper wall 34 also has a corner transition to the upper flange 22 and the lower wall 36 has a corner transition to the lower flange 24, which are each also defined by longitudinal bends in the sheet material of the second sill panel 14. Again, the corner transitions between the upper and lower walls 34, 36 and the upper and lower flanges 22, 24 and the outer wall 32 may have an angular transition greater or less than shown in FIG. 4, such as approximately between 40 and 120 degrees, between 70 and 100 degrees, between 80 and 95 degrees, or between 82 and 92 degrees.

As shown in FIG. 3, the upper and lower flanges 22, 24 are substantially planar and oriented in parallel alignment with the planar extent of the outer wall 32. The upper and lower walls 34, 36 of the second sill panel 14 are also substantially planar, but are slightly angled from being orthogonal to the outer wall 32 and flanges 22, 24. With the flanges 18, 20, 22, 24 of the panels 12, 14 attached together, the walls thereof define a substantially hexagonal cross-sectional shape; however, it is appreciated that additional examples of the rocker insert may have various alternative cross-sectional shapes (e.g., a substantially rectangular shape) and different wall configurations for the corresponding vehicle design (e.g., portions of the inner or outer walls that are not vertically oriented). It is also contemplated that in other examples the outer sill and the inner sill may each include a different configuration including but not limited to the outer sill having an inward or outward protruding stiffening rib portion configured to provide additional stiffness and side impact support.

As further shown in FIGS. 3 and 4C, the vehicle rocker assembly 10 includes a rocker insert 40 disposed within the elongated hollow interior 16. The rocker assembly 10 includes a stiffening member 42 defining a plurality of enclosed sections 44 extending along a length of the elongated interior. Each of the plurality of enclosed sections 44 are configured to carry a load path laterally between the inboard and the outboard wall portions. The stiffening member may be comprised of aluminum and/or produced using an extrusion process. Other materials and production processes have also been contemplated. In some examples, the plurality of enclosed sections are an identical structural shape repeated over the length of the hollow interior. In other examples, the plurality of enclosed sections may have slight variations between the plurality of enclosed sections or may include modifications for an end portion or to accommodate other vehicle components.

Referring still to the example shown in FIGS. 3 and 4C, a cross-sectional shape of the plurality of enclosed sections 44 comprises a consistent cross-sectional shape extending in the lateral vehicle direction. The plurality of enclosed sections 44 includes a crest 62 defined as a highest point of the plurality of enclosed sections 44 and a base 64 defined as a lowest point of the plurality of enclosed sections 44. In one example, the crest 62 of the plurality of enclosed sections 44 extends between the first side edge 52 and the second side edge 54. In other words, the crest 62 of the plurality of enclosed sections 44 extends at least partially between the sill inner and the sill outer, if included. As shown in the example illustrated in FIGS. 3 and 4C, the base 64 of the plurality of enclosed sections 44 also extends between the first side edge 52 and the second side edge 54.

The lateral vehicle direction generally extends across the width dimension of the vehicle. In contrast, the longitudinal vehicle direction generally extends along the length dimension of the vehicle. In some examples, the crest 62 may be disposed in a generally horizontal plane. The crests 62 of the plurality of enclosed sections 44 are configured to be oriented to generally align with anticipated lateral impacts to the side of a vehicle, so as to provide increased stiffness to the corresponding portion of the upper or lower wall of the rocker insert 40. Moreover, the crest 62 of the plurality of enclosed sections 44 extends at least partially between the sill wall portions of the sill inner 12 and the sill outer 14. In some examples the plurality of enclosed sections 44 may be across an entire surface or may be disposed on only a portion of the surface. The crests 62 and the bases 64 may generally flat of may be of any shape and side as desired, including but not limited to the crest 62 being a v-shape or a u-shape and/or the base 64 being a v-shape or a u-shape. It is also contemplated that the crest 62 and the base 64 may be the same shape or may be different shapes than one another, if desired. Moreover, it is contemplated that the crests 62 and/or the bases 64 may be a single repeating shape, may be alternating shapes, or any pattern as desired.

In some examples, a height of the crest 62 is the same as the depth of the lowest point on the base 64. However, it is also contemplated that the height of the crest 62 and the depth of the lowest point on the base 64 may be different than one another such that the height of the crest 62 is larger than the depth of the base 64 or vice versa. Additionally, it is contemplated that the heights of the crests 62 may remain constant along the plurality of enclosed sections 44. However, it is also contemplated that the height of the crests 62 may be variable along the plurality of enclosed sections 44. Similarly, it is contemplated that the depth of the base 64 may remain constant along the plurality of enclosed sections 44. However, it is also contemplated that the depth of the base 64 may be variable along the plurality of enclosed sections 44.

In some examples, a width of the crest 62 is the same width as the base 64. However, it is also contemplated that the width of the crest 62, measured from a center of one base 64 to the center of an adjacent base 64, and the width of the base 64, measured from one crest 62 to another crest 62, may be different than one another such that the width of the crest 62 is larger than the width of the base 64 or such that the width of the base 64 is larger than the width of the crest 62. Moreover, it is contemplated that the width of the crests 62 may remain constant along the length of the plurality of enclosed sections 44. However, it is also contemplated that the width of the crest 62 may be variable along the plurality of enclosed sections 44. Similarly, it is contemplated that the width of the bases 64 remain constant along the length of the plurality of enclosed sections 44. However, it is also contemplated that the width of the base 64 may be variable along the plurality of enclosed sections 44.

In some examples, the base 64 has a width of approximately 0.5-1.5 mm. In other examples the base 64 has a width of approximately 0.8-1.3 mm. In yet another example, the base 64 has a width of approximately 0.9-1.1 mm. In one example, the base 64 has a width of approximately 0.9 mm. In another example, the base 64 has a width of approximately 1.1 mm. However, various other base 64 widths have been contemplated.

In the example shown in FIGS. 3 and 4, the cross-sectional shape begins at the crest 62 which is a generally flat surface. The cross-sectional shape then is generally rounded as it extends towards the base 64. In some examples, the base is also a generally flat surface. In some examples, the cross-sectional shape is symmetrical such that the cross-sectional shape extends generally rounded back to the crest 62 generally forming a circular or oval shape with flat surface on the top and bottom. Moreover, the cross-sectional shape of the plurality of enclosed sections also includes connecting portions 66 which extend from the circular shape and couple a second circular shape to the first circular shape. In some examples the connecting portions 66 are generally straight and extend between the first cross-sectional shape of the plurality of enclosed sections and the second cross-sectional shape of the plurality of enclosed sections approximately half way between the crest 62 and the base 64. However, various other locations of the connecting portions 66 have been contemplated including from extending near the crest 62 or the base 64. Moreover, it is contemplated that the connector portion may couple the first cross-sectional shape and the second cross-sectional shape of the plurality of enclosed sections at an angle other than parallel to the top wall of the rocker insert, including but not limited to between a 10-80 degrees, between 20-70 degrees, between 30-60 degrees, or 40-50 degrees. Additionally, in some examples, the plurality of enclosed sections 44 may include cut out portions to accommodate other vehicle components and/or for packaging purposes. Typically the cut out portions are disposed adjacent a first end or a second end of the plurality of enclosed sections, however, various other configurations have been contemplated.

The rocker insert 40 may also include a top wall 80, a bottom wall 82, and a first side wall 84, which may comprise a channel section, such as a U-shaped or hat-shaped beam that is formed by the interconnection of the top wall 80, the bottom wall 82, and the first side wall 84. In the example shown in FIGS. 3-5B, the rocker insert 40 includes the top wall 80, the bottom wall 82 disposed generally parallel to the top wall 80, and the first side wall 84 which extends between the top wall 80 and the bottom wall 82. In some examples, the crest 62 of the enclosed sections 44 is disposed adjacent to the top wall 80. Moreover, in some examples, the base 64 of the enclosed sections 44 is disposed adjacent to the bottom wall 82. Further in some examples, the crest 62 of the enclosed sections 44 is coupled to the top wall 80, such as by welding. Moreover, in some examples the base 64 of the enclosed sections 44 is coupled to the bottom wall 82, such as by welding. Various other coupling methods have also been contemplated.

In some examples, the top wall 80 and the bottom wall 82 are generally flat parallel extending surfaces, however various other implementations have been contemplated including corrugation disposed on one or more of the top wall 80 and the bottom wall 82. In the example shown, the top wall 80 and the bottom both have flange portions 88 which extend at an angle from the top wall 80 and the bottom wall 82. The angle between the flange portion 88 and the top or bottom wall 82 may be approximately ninety degrees, however, various other angles have been contemplated including but not limited to angles in the 25-125 degree range. The flange portions 88 are configured to allow the rocker insert 40 to be coupled to another vehicle component such as a sill inner, a sill outer, or other vehicle component.

Moreover, in the example shown, the side wall 84 curved outward from both the top surface and the bottom surface before curving back inwards, towards the wave-shaped portion, and meeting at a recessed portion 90. In some examples, the recessed portion 90 is curved such that it has a generally c-shape, however various other shapes have been contemplated. In some examples, one or more of the top wall 80 or the bottom wall 82 may include cut-outs to accommodate other vehicle components without departing from the spirit of the invention.

Referring still to the example shown in FIGS. 3-5B, it is contemplated that one of the side wall and or the flange portions 88 of the top and bottom wall 82 may be coupled to one of the inner sill or the outer sill to support the rocker insert 40 in the elongated hollow interior 16. Again, this coupling may be through welding, however, other coupling methods have been contemplated including but not limited to the use of fasteners or adhesive. In one example, the side wall is coupled to the inner sill. In another example, the side wall is coupled to the outer sill. In another example, the flange portions 88 of the top and/or bottom wall 82 are coupled to the outer sill. In another example, the flange portions 88 of the top and/or bottom wall 82 are coupled to the inner sill.

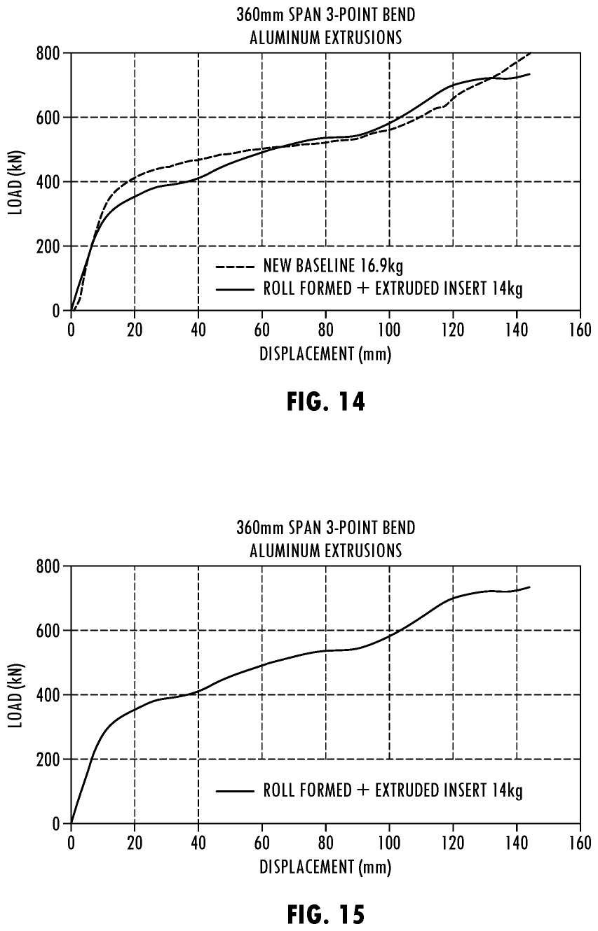

In operation, the rocker assembly 10 as described herein is designed to support the vehicle and undergo and absorb certain levels of impact forces, such as to prevent distances of inboard intrusion into the vehicle in accordance with insurance requirements and other regulatory and legal requirements. The rocker assembly 10 as described herein provides an improved force vs displacement curve as illustrated in FIGS. 14 and 15, which leads to improved side impact testing results as illustrated.

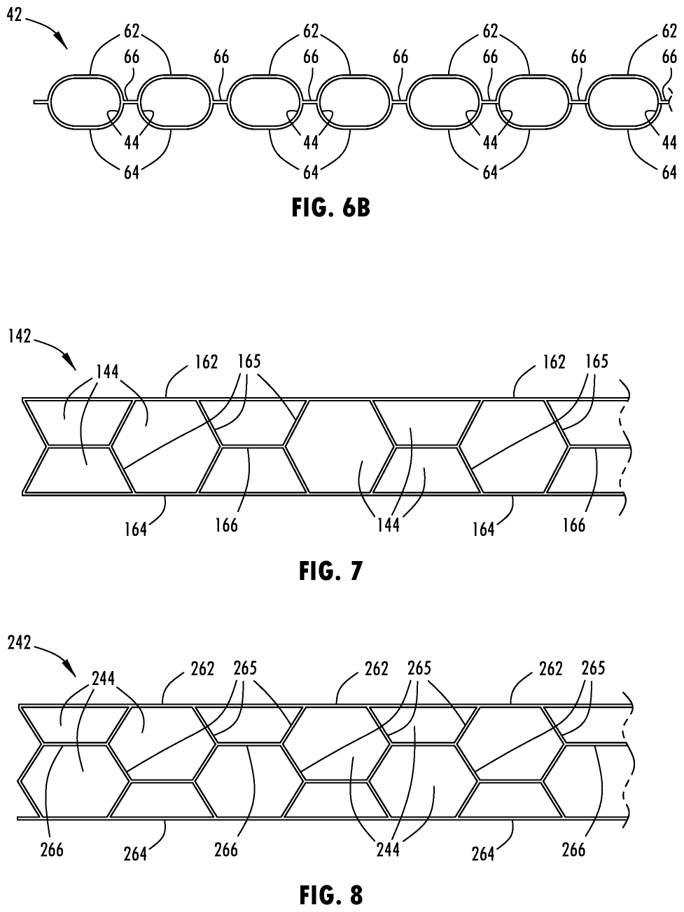

Referring now to the example shown in FIG. 7, the rocker assembly 110 includes similar features to the features described above with respect to the rocker assembly 10 shown in FIGS. 1-6B, including but not limited to the one more of the sill outer or sill inner, and the rocker insert including the top wall, the bottom wall, and the side wall, such a channel section or beam having a U-shaped cross-section for receiving a stiffening member 142 having a plurality of enclosed sections 144. However, as illustrated in the example shown in FIG. 7, the plurality of enclosed sections 144 have a generally hexagonal shape. In the example shown, the crest 162 of the plurality of enclosed sections 144 is generally flat and configured to engage the top wall 180 of the rocker insert 140 and having a similarly shaped base 164 which is generally flat and configured to engage the bottom wall 184 of the rocker insert 140. Moreover, the plurality of enclosed sections 144 includes side walls 165 which extend at a generally 45 degree angle from the crest 162 and base 164 of the plurality of enclosed sections 144 until they meet one another, providing a hexagonal shape. Moreover, connecting portions 166 are disposed between the repeating hexagonal shapes and extend between the side walls 165. Similar to the connecting portions 166 described above, the connecting portions 166 extend between the first cross-sectional shape and the second cross-sectional shape approximately equidistant from the crest 162 and the base 164 and in generally parallel alignment with the top and bottom walls of the U-shaped beam. However, various other configurations have been contemplated.

Referring now to the example shown in FIG. 8, the rocker assembly 210 includes similar features to the features described above with respect to the rocker assembly 10 shown in FIGS. 1-6B, including but not limited to the one more of the sill outer or sill inner, and the rocker insert including the top wall, the bottom wall, and the side wall, such as a channel section or a beam having a U-shaped cross-section for receiving a stiffening member 242 defining the plurality of enclosed sections 244. However, as illustrated in the example shown in FIG. 8, the plurality of enclosed sections 244 have a different geometric shape. More specifically, the plurality of enclosed sections 244 include hexagonal shapes with the crest 262 and a half-hexagonal shape disposed below the hexagonal shape and including the base 264. In the example shown, the crest 262 of the plurality of enclosed sections 244 is generally flat and configured to engage the top wall of the rocker insert and having the base 264 which is also generally flat and configured to engage the bottom wall of the rocker insert. However, the base 264 of the plurality of enclosed sections 244 which is configured to engage the bottom wall of the rocker insert has a longer length than the base 264. Moreover, the plurality of enclosed sections 244 includes side walls 265 which extend at a generally 45 degree angle from the crest and base of the plurality of enclosed sections until they meet one another, giving the hexagonal shape. Moreover, connecting portions 266 are disposed between the repeating hexagonal shape and extend between the side walls. Similar to the connecting portions 66 described above, the connecting portions 266 extend between the first cross-sectional shape and the second cross-sectional shape. However, in the example shown, the connecting portions 266 extend between the first cross-sectional shape and the second cross-sectional shape at a location closer to the top wall of the rocker insert than to the bottom wall of the rocker insert. However, various other configurations have been contemplated.

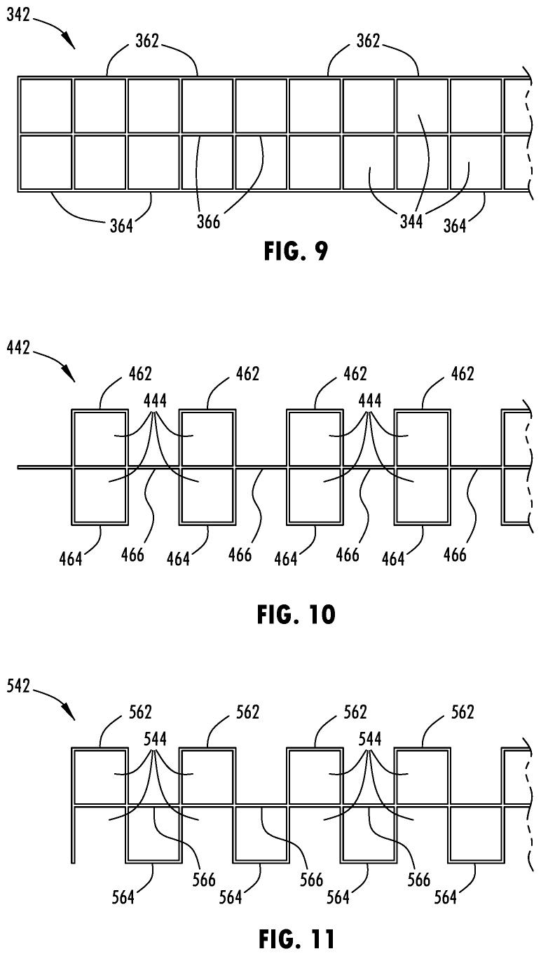

Referring now to the example shown in FIG. 9, the rocker assembly 310 includes similar features to the features described above with respect to the rocker assembly 10 shown in FIGS. 1-6B, including but not limited to the one more of the sill outer or sill inner, and the rocker insert including the top wall, the bottom wall, and the side wall, such as a channel section or a beam having a U-shaped cross-section for receiving a stiffening member 342 defining the plurality of enclosed sections 344. However, as illustrated in the example shown in FIG. 9, the plurality of enclosed sections 344 has a different cross-sectional shape. In the example shown in FIG. 9, the shape is continuous rectangular shapes which extend adjacent to one another such that a side wall of one repeating shape is shared which the adjacent repeating shape. Moreover, the plurality of enclosed sections 344 include connecting portions 366 which extend along the entire length. In the example shown, the connecting portions 366 are disposed approximately equidistant between the top wall and the bottom wall. However, various other configurations have been contemplated.

Referring now to the example shown in FIG. 10, the rocker assembly 410 includes similar features to the features described above with respect to the rocker assembly 10 shown in FIGS. 1-6B, including but not limited to the one more of the sill outer or sill inner, and the rocker insert including the top wall, the bottom wall, and the side wall, such as a channel section or a beam having a U-shaped cross-section for receiving a stiffening member 442 defining the plurality of enclosed sections 444. However, the shape of the enclosed sections 444 includes a plurality of rectangles which are joined together using connecting portions 466. In the example shown, the repeating shapes are separated from one another, however, the connecting portions 466 extend through the repeating shapes generally forming a top square and a bottom square. Additionally, in the example shown, the connecting portions 466 are disposed approximately equidistant between the top wall and the bottom wall. However, various other configurations have been contemplated.

Referring now to the example shown in FIG. 11, the rocker assembly 510 includes similar features to the features described above with respect to the rocker assembly 10 shown in FIGS. 1-6B, including but not limited to the one more of the sill outer or sill inner, and the rocker insert including the top wall, the bottom wall, and the side wall, such as a channel section or a beam having a U-shaped cross-section for receiving a stiffening member 542 defining the plurality of enclosed sections 544. Moreover, the plurality of enclosed sections 544 is similar to the plurality of enclosed sections 444 illustrated in FIG. 10, except for the rectangular structure does not include a bottom wall which encloses the plurality of enclosed sections. Instead, a bottom wall is disposed between the plurality of enclosed sections and acts as a second connecting portion 566. It is also contemplated that the second connecting portion 66 may be disposed along the top wall, if desired.

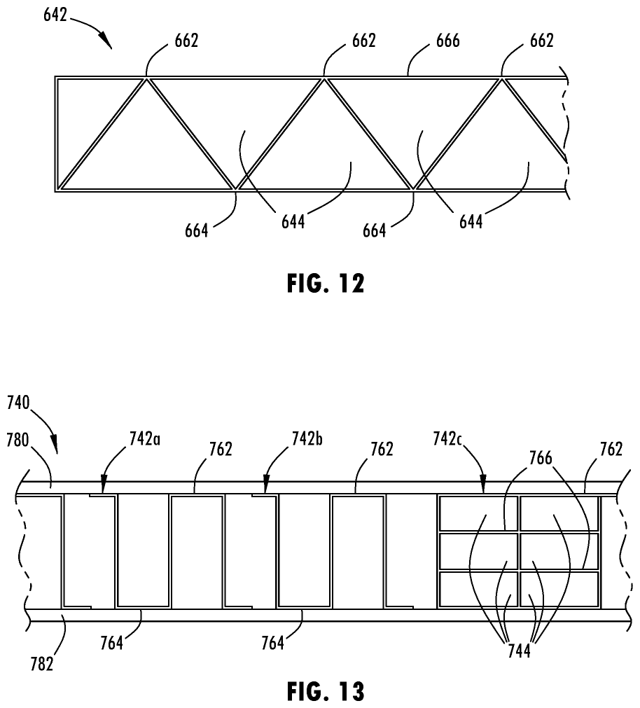

Referring now to the example shown in FIG. 12, the rocker assembly 610 includes similar features to the features described above with respect to the rocker assembly 10 shown in FIGS. 1-6B, including but not limited to the one more of the sill outer or sill inner, and the rocker insert including the top wall, the bottom wall, and the side wall, such as a channel section or a beam having a U-shaped cross-section for receiving a stiffening member 642 defining the plurality of enclosed sections 644. However, the plurality of enclosed sections 644 has a general v-shape disposed between upper and lower continuous connecting portions 666, so as to enclose repeating triangular shaped enclosed sections that alternate in an upright configuration with the point (or crest 662) at the top and a downward configuration with the point (or base 664) at the bottom.

Referring now to the example shown in FIG. 13, the rocker assembly 710 includes similar features to the features described above with respect to the rocker assembly 10 shown in FIGS. 1-6B, including but not limited to the one more of the sill outer or sill inner, and the rocker insert including the top wall 780, the bottom wall 782, and the side wall, such as a channel section or a beam having a U-shaped cross-section for receiving a stiffening members 742a, 742b, 742c defining the plurality of enclosed sections 744. However, the stiffening member is divided into separate stiffening members 742a, 742b, 742c, with each having a different sectional shape, such as to provide tailored stiffness at different sections along the length of the rocker insert 740 and corresponding rocker assembly. As shown in FIG. 13, the stiffening member 742a has a cross section with an S-shape that provides three vertical walls extending between the top and bottom walls 780, 782 with the three vertical walls connect by an upper wall (or crest 762) and a lower wall (or base 764). Similarly, the stiffening member 742b also has a cross section with an S-shape that provides three walls extending between the top and bottom walls 780, 782 with the three vertical walls connect by an upper wall (or crest 762) and a lower wall (or base 764), but the upper and lower walls being shorter than the stiffening member 742a, so as to reduce the spacing between the vertical walls. Further, the stiffening member 742c has a plurality of enclosed sections 744 provided as a plurality of rectangles joined together using connecting portions 766. In the example shown in FIG. 13 the stiffness of the stiffening member 742a is less than the stiffening member 742b, and the stiffness of the stiffening member 742b is less than the stiffening member 742c.

It is also contemplated that the internal reinforcements of the disclosed vehicle rocker assembly may be incorporated in other types of structural beams, such as to support and sustain different loading conditions, such as for supporting certain horizontal spans or axial loading conditions. Also, the vehicle component may be designed to undergo various impact forces, such as for the illustrated rocker assemblies, pillar structures, and the like. The cross-sectional geometry, material type selections, and material thickness within the cross-sectional profile of the vehicle component may be configured for such a particular use and the desired loading and performance characteristics, such as the weight, load capacity the beam, force deflection performance, and impact performance of the vehicle component.

For purposes of this disclosure, the articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A vehicle rocker assembly comprising:
one or more of a sill outer or a sill inner to define an elongated hollow interior defined by one or more of an inboard wall portion of the sill inner and an outboard wall portion of the sill outer; and
a rocker insert disposed within the elongated hollow interior, the rocker insert comprising:
a channel section having a top wall, a bottom wall, and a side wall coupled to and extending between the top wall and the bottom wall, with the top wall, the bottom wall, and the side wall at least partially defining a second hollow interior; and
a stiffening member at least partially disposed within the second hollow interior and configured to be produced by extrusion, the stiffening member defining a plurality of enclosed sections extending along a length of the elongated hollow interior; and
wherein each of the plurality of enclosed sections are configured to carry a load path laterally between the inboard and outboard wall portions.

2. The vehicle rocker assembly of claim 1, each of the plurality of enclosed sections have the same cross-sectional shape extending in a lateral vehicle direction.

3. The vehicle rocker assembly of claim 1, wherein the stiffening member comprises a single integral piece.

4. The vehicle rocker assembly of claim 1, wherein the stiffening member is formed by extrusion with an aluminum alloy.

5. The vehicle rocker assembly of claim 1, wherein the stiffening member comprises a plurality of stiffening sections arranged along the channel section, and wherein the plurality of stiffening sections include different cross-sectional shapes configured to have different stiffnesses at a corresponding section of the length of the hollow interior.

6. The vehicle rocker assembly of claim 1, wherein the plurality of enclosed sections comprise a shape with a series of highest points extending in parallel with each other.

7. The vehicle rocker assembly of claim 1, wherein a highest point of the enclosed sections and a lowest point of the enclosed sections are disposed on the same vertical plane.

8. The vehicle rocker assembly of claim 1, wherein a highest point of the enclosed section extends at least partially between the sill wall portions of the sill inner and the sill outer.

9. The vehicle rocker assembly of claim 1, wherein the channel section of the rocker insert is formed by a metal sheet.

10. The vehicle rocker assembly of claim 1, wherein the side wall is coupled with the sill inner or the sill outer to support the rocker insert in the elongated hollow interior.

11. The vehicle rocker assembly of claim 1, wherein the stiffening member comprise a series of interconnected walls that surround the plurality of enclosed section and extend in a lateral vehicle direction perpendicular to a horizontal plane extending along a longitudinal axis of a vehicle.

12. The vehicle rocker assembly of claim 1, wherein the plurality of enclosed sections comprise a plurality of repeating hollow shapes selected from a circular shape, a hexagonal shape, a square shape, or a rectangular shape.

13. A reinforcement insert disposed within an elongated interior of a vehicle component, the reinforcement insert comprising:
a channel section at least partially surrounding a hollow interior; and
a stiffening member at least partially disposed within the hollow interior and having a consistent cross-sectional shape extending in a direction configured to carry a load path transverse to a length of the elongated interior of the vehicle component;
wherein the stiffening member comprises a plurality of enclosed sections disposed along the hollow interior of the channel and configured to be spaced along the length of the elongated interior of the vehicle component.

14. The reinforcement insert of claim 13, wherein the stiffening member is a single integral piece.

15. The reinforcement insert of claim 13, wherein the stiffening member comprise a series of interconnected walls that surround the plurality of enclosed sections, and wherein the series of interconnected walls extending in the direction that is configured to axially carry the load path.

16. The reinforcement insert of claim 15, wherein the plurality of enclosed sections of the rocker insert are formed by extrusion in a direction oriented in a lateral vehicle direction.

17. The reinforcement insert of claim 13, wherein a cross-sectional shape of the plurality of enclosed sections comprises a shape with a series of highest points extending in parallel with each other.

18. The reinforcement insert of claim 13, each of the plurality of enclosed sections have the same cross-sectional shape extending in a lateral vehicle direction.

19. The reinforcement insert of claim 13, wherein the channel section comprises a top wall, a bottom wall, and a side wall coupled to and extending between the top wall and the bottom wall, with the top wall, the bottom wall, and the side wall at least partially defining the hollow interior.

20. A vehicle rocker assembly comprising:
a sill section having a wall portion that borders along an elongated hollow interior of the sill section; and
a rocker insert disposed within the elongated hollow interior, the rocker insert comprising:
a channel section having a top wall, a bottom wall, and a side wall coupled to and extending between the top wall and the bottom wall, with the top wall, the bottom wall, and the side wall at least partially defining a second hollow interior; and
a stiffening member at least partially disposed within the second hollow interior and configured to be produced by extrusion, the stiffening member comprising a series of interconnected walls that surround a plurality of enclosed sections extending along a length of the elongated hollow interior, and
wherein the series of interconnected walls extend in the direction that is configured to axially carry a load path laterally between the inboard and outboard wall portions.
